(19) United States
(12) Patent Application Publication
(10) Pub. No.: US 2003/0205415 A1
(43) Pub. Date: Nov. 6, 2003

(54) Self-propelled vehicle particularly for making turns with small turning radii

(76) Inventor: Massimiliano Ruffo, Verona (IT)

Correspondence Address: MODIANO & ASSOCIATI, Via Meravigli, 16, MILANO, 20123, IT

(21) Appl. No.: 10/454,669

(22) Filed: Jun. 5, 2003

Related U.S. Application Data
(63) Continuation-in-part of application No. PCT/EP01/13947, filed on Nov. 29, 2001.

(30) Foreign Application Priority Data
Dec. 7, 2000 (IT) VR2000A000119

(51) Int. Cl. B62D 6/00

(52) U.S. Cl. 180/6.2

(57) ABSTRACT

A self-propelled vehicle capable of making turns with tight turning radii, which comprises a frame with a pair of traction wheels, at least one orientable wheel, and one or more driver's posts. The vehicle has a single motor that is kinematically connected to a driving shaft and means for functional connection between the driving shaft and each one of the two traction wheels. Each one of the two traction wheels can therefore be actuated independently of the other thanks to the presence of steering means suitable to act on the connection means.

### CROSS-REFERENCE TO RELATED APPLICATIONS

This application is a continuation-in-part of PCT Application No. PCT/EP01/13947 filed on Nov. 29, 2001.

### FIELD OF THE INVENTION

The present invention relates to a self-propelled vehicle particularly for making turns with small turning radii.

### BACKGROUND OF THE INVENTION

It is known that self-propelled vehicles are already commercially available which allow to make turns with small turning radii.

Vehicles, such as self-propelled excavators or others, which currently allow to make turns with small turning radii generally use motors that drive one traction wheel each, so as to allow the vehicle to turn about the wheel to which rotation is not transmitted at a given time and which therefore acts as a pivot.

If achieving turns with even tighter turning radii is sought, the two driving wheels can be made to turn even in opposite directions.

In a vehicle of the above described type, since the rotation of each driving wheel is controlled by a motor and by a control unit, which is generally hydraulic, high manufacturing and maintenance costs are incurred for such motor.

### SUMMARY OF THE INVENTION

The aim of the invention as described hereinafter is to provide a self-propelled vehicle that is capable of making turns with small turning radii without suffering the above mentioned drawbacks.

An object of the present invention is to provide a self-propelled vehicle having a new transmission and steering system that has immediate response and high reliability.

Another object of the present invention is to provide a self-propelled vehicle that is constructively very simple, easy to use and low in cost.

This aim and these and other objects that will become better apparent hereinafter are achieved by a self-propelled vehicle capable of making turns with tight turning radii, having a frame with a pair of traction wheels, at least one orientable wheel, at least one driver's post, characterized in that it comprises a single motor, a driving shaft kinematically connected to said motor, means for functional connection between said driving shaft and each wheel of said pair of traction wheels, which can thus be actuated independently of the other wheel, and steering means adapted to act on said functional connection means.

### BRIEF DESCRIPTION OF THE DRAWINGS

Further characteristics and advantages of the present invention will become better apparent from the following detailed description of a preferred but not exclusive embodiment of a self-propelled vehicle illustrated in the accompanying drawing, wherein the only FIGURE is an exploded perspective view of a self-propelled vehicle provided with a traction and steering apparatus according to the invention.

### DESCRIPTION OF THE PREFERRED EMBODIMENTS

With reference to the drawing, a self-propelled vehicle 1 according to the invention comprises a frame 2 on which there is a driver's post 3. The frame 2 of the vehicle supports in any suitable manner a motor 4, which can be any of an electric or internal-combustion type, and two traction wheels 5, which are preferably mounted so that they can turn about a same axis.

The motor 4 is designed to actuate a driving shaft or motion distribution shaft 6, which is rotatably supported by the frame 2. This actuation can be achieved advantageously by means of a V-belt 7, which transmits the motion from a first pulley 8 keyed to the output shaft of the motor 4 to a second pulley 9 keyed to the driving shaft 6. The kinematic connection between the motor 4 and the shaft 6 can in any case also be achieved in another manner, for example by means of a chain link, a gear transmission and a direct-drive arrangement.

The motor shaft 6 is designed to provide rotary motion to the two traction wheels 5 independently of each other by way of functional connection means that comprises two intermediate shafts 10, which are parallel to the driving shaft 6 and can oscillate with respect to the shaft 6, each supporting a driven pulley 11 and a driving pulley 12 which are connected one another, as explained hereinafter. The driven pulley 11 receives its motion from the driving shaft 6 by means of an elastic belt 13, while the driving pulley 12 transmits motion to a traction pulley 14 that rotates rigidly with a respective traction wheel 5 by means of a belt 15, which is also elastic.

Since the intermediate shaft 10 oscillates with respect to the frame 2, it can move toward or away from the axis of the respective traction wheel 5. This entails the possibility to increase or decrease the tension of the belt 15, with the result that if the tension of the belt 15 is reduced, the belt 15 slips on the traction pulley 14, consequently making it impossible to transfer the rotary motion to the traction wheel 5.

In the exemplary embodiment shown in the drawing, the oscillating movements of the intermediate shaft 10 are actuated by a lever 16, having one end articulated to a pivot 16a that can be fixed to the frame 2 and the other end advantageously shaped as a control handle for the application of force on the part of the operator's hand. In an intermediate position, and advantageously proximate to its pivot 16a, the lever 16 further has a hole 17 for accommodating a supporting pivot for an intermediate shaft 10. A second supporting element 18 for said intermediate shaft 10 is pivoted to the pivot 16a of the lever 16 and forms with it a fork-like component. The supporting element 18, if required, can be anchored to any other suitable point of the lever 16.

The lever 16 and the supporting element 18 allow to support each shaft 10 and rigidly couple it to the lever 16. This implies that through the actuation of the lever 16 the user can control the oscillating motion of the shaft 10 and accordingly can act on the functional connection between the driving shaft 6 and the two traction wheels 5.

The angular strokes of the lever 16 are controlled by two opposite springs 19, which tend to keep the lever 16 in an intermediate (vertical) inactive position, in which both traction wheels 5 are operatively connected to the shaft 10 and therefore to the motor 4, so that, when the motor is running, the vehicle 1 moves along a straight path.

The springs 19 are connected to the opposite sides of an element 22 protruding laterally from the frame 2 and defining a slot through which the lever 16 passes and adapted to define the stroke of the lever 16.

The connection between the driven pulley 11 and the driving pulley 12 occurs advantageously by interposing a torque-resistant coupling 20 of any suitable kind meant to damp the peaks of quantity of motion during engagement transients.

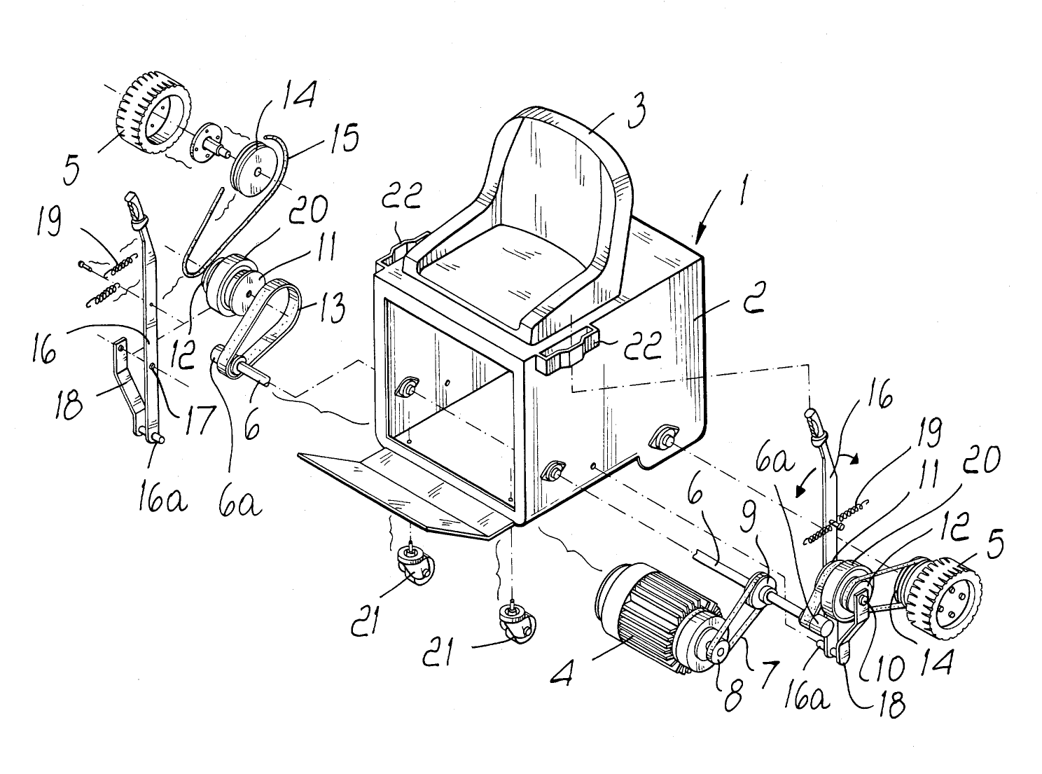

Advantageously, the motor shaft 6 is provided, for example at one of its ends, with a respective reverse motion wheel 6a, while the driving pulleys 12 are kinematically connected to a respective motion inversion wheel that, in FIG. 1, is arranged coaxially with the torque resistant coupling 20 and is supported by the respective intermediate shaft 10.

The arrangement of the reverse motion wheel 6a and of the respective motion inversion wheel is such that, in case the user, by acting upon the lever 16, causes the intermediate shaft 10 to oscillate, i.e. to bring it towards the motor shaft 6, the lateral surfaces of the reverse motion wheel 6a and of the motion inversion wheel, respectively, are brought in contact one with the other and thus in a kinematic coupling.

In this way, it is possible to invert the rotation of one or both the traction wheels 5 (inverting, in practice, the rotation of the driving pulleys 12 that are kinematically connected, or in any case connectable, to the external surface of the torque-resistant coupling 20) by acting directly upon one or both levers 16.

In case both the motion inversion wheels are kinematically coupled to the respective reverse motion wheels 6a, a reverse motion of the vehicle will be obtained while, if only one of the motion inversion wheel is kinematically coupled to the respective reverse motion wheel 6a (while keeping, at the same time, the other lever 16 in an intermediate position), it is possible to further reduce the steering radius causing the vehicle to steer about its axis.

The vehicle 1 further has at least one and preferably two self-orientating wheels 21, which allow easy steering of the vehicle, avoiding slippage on the surface on which the vehicle rests.

When the operator does not act on the levers 16, the springs 19 keep such levers in the inactive vertical position. In this condition, the belts 13 and 15 are tensioned and therefore the traction wheels 5 are both operatively connected to the driving shaft 6; this position of the two levers 16 accordingly allows the two traction wheels 5 to have the same rotation rate. The rotation rate of the two traction wheels can be optionally controlled by the operator by means of a conventional device for controlling the rotation rate of the motor 4 (a rheostat in the case of an electric motor, an accelerator lever in the case of an internal-combustion engine), but in this configuration the vehicle 1 moves in a straight line.

If the operator wishes to steer the vehicle 1 for example to the right, he acts by moving back the lever 16 located to his right. The movement of the lever 16 reduces the distance between the intermediate shaft 10 and the axis of the right traction wheel 5, and this entails loosening the tension of the belt 15. At this point, the belt 15, by slipping around the traction pulley 14, does not transmit motion to the right wheel 5, which accordingly remains motionless and free. Since the left traction wheel is always engaged in motion with the driving shaft 6, it still has a given rotation rate, which allows the vehicle to turn right about the right traction wheel, which by having a zero rotation rate acts as a rotation pivot, so that the vehicle steers to the right with the smallest turning radius.

The same operation, performed with the left lever 16, allows the vehicle to turn left.

It is evident that the described self-propelled vehicle 1 allows to achieve the above aim and objects, especially as regards low production costs, constructive simplicity and high reliability.

All the details may further be replaced with other technically equivalent elements.

The materials used, as well as the dimensions, may be any according to requirements.

The disclosures in Italian Patent Application No. VR2000A000119 from which this application claims priority are incorporated herein by reference.

What is claimed is:

1. A self-propelled vehicle capable of making turns with tight turning radii, having a frame with a pair of traction wheels, at least one orientable wheel, at least one driver's post, comprising a single motor, a driving shaft that is kinematically connected to said motor, means for functional connection between said driving shaft and each wheel of said pair of traction wheels, which can thus be actuated independently of the other wheel, and steering means adapted to act on said functional connection means.

2. The self-propelled vehicle according to claim 1, wherein said functional connection means comprises an intermediate rotatable shaft, at least two driven wheels keyed on said intermediate shaft and kinematically connected with a motion transmission linkage to said motor, a driving wheel that can be turned with each driven wheel, and means for rigidly rotationally coupling each driving wheel with a respective traction wheel.

3. The self-propelled vehicle according to claim 2, further comprising an elastic transmission belt between said driving shaft and each driven wheel.

4. The self-propelled vehicle according to claim 2, wherein said means for rigidly rotationally coupling each driving wheel with the respective traction wheel comprises a belt or a chain.

5. The self-propelled vehicle according to claim 2, wherein said steering means comprises a lever element that is suitable to rotatably support a driven wheel and a driving wheel so as to perform angular strokes of said driving and driven wheels toward and away from said driving shaft.

6. The self-propelled vehicle according to claim 5, wherein said lever element has an end that acts as a fulcrum and is pivoted on said frame and another end that is configured like a control handle.

7. The self-propelled vehicle according to claim 7, wherein said lever element comprises a first support located in a straddling position.

8. The self-propelled vehicle according to claim 6, wherein said lever element is elastically loaded.

9. The self-propelled vehicle according to claim 2, further comprising a torque-resistant coupling for mutually connecting each driven wheel and the respective wheel.

10. The self-propelled vehicle according to claim 2, comprising at least one reverse motion wheel integral in its rotation with said motor shaft, said reverse motion wheel being adapted to actuate a respective motion inversion wheel which is supported by said intermediate shaft, when said intermediate shaft is approached to said motor shaft.
